(19) United States
(12) Patent Application Publication
(10) Pub. No.: US 2012/0085297 A1
(43) Pub. Date: Apr. 12, 2012

(54) Boom Box Dog Collar

(76) Inventor: Gina Brown, Nashville, TN (US)

(21) Appl. No.: 13/232,409

(22) Filed: Sep. 14, 2011

Related U.S. Application Data
(60) Provisional application No. 61/390,670, filed on Oct. 7, 2010.

(51) Int. Cl. A01K 27/00

(52) U.S. Cl. 119/859

(57) ABSTRACT

An architecture is presented that provides an audio dog collar system. The audio dog collar system comprises a pet collar for securing the audio dog collar to a pet and an audio player secured to the pet collar. The audio player comprises a USB port that utilizes a USB cable to upload songs and playlists directly from a computer to the audio player. Further, the audio player could also comprise a memory card port that utilizes a memory card. The memory card stores songs and playlists to be uploaded to the audio player. Furthermore, the audio dog collar system comprises a remote control to control operations of the audio player, weather-resistant speakers, and a rechargeable battery. Additionally, the audio player is contained within a zippered compartment of the pet collar for easy access.

### CROSS-REFERENCE

This application claims priority from Provisional Patent Application Ser. No. 61/390,670 filed Oct. 7, 2010.

### BACKGROUND

Many pet owners enjoy listening to music while running, playing or walking with their pets. However, enjoying these activities while holding a music player can be inconvenient. For example, pet owners may have difficulty trying to hold onto the music player while picking up and throwing pet toys, petting their pets, or interacting with their pets in general. Also, many music players require the use of headphones, which can get caught on surrounding objects while pet owners are active with their pets. Furthermore, some pet owners may want to share their music with others without the constrictions that headphones impose. It would be convenient to have a device that is able to play music aloud, is hands-free, and is convenient.

Consequently, a need exists for an audio dog collar that allows users and their pets to listen to music while walking, running and/or playing together. The audio dog collar provides users with, among other features, a speaker system with volume control such that users may share their music with others. Music is played aloud while a pet walks outside, walks around inside a house, rides in a car, is held in a user's arms, etc. Thus, the audio dog collar provides pet owners with a convenient device for listening to music while engaging with their pets.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an audio dog collar system. The audio dog collar system comprises a pet collar for securing the audio dog collar to a pet and an audio player secured to the pet collar. The audio player comprises a Universal Serial Bus (USB) port for uploading songs and playlists. Specifically, the USB port utilizes a USB cable to upload songs and playlists directly from a computer to the audio player. Further, the audio player could also comprise a memory card port that utilizes a memory card. The memory card stores songs and playlists to be uploaded to the audio player.

Furthermore in the preferred embodiment of the present invention, the audio dog collar system comprises a remote control to control operations of the audio player, weather-resistant speakers, and a rechargeable built-in battery. Additionally, the audio player is contained within a zippered compartment of the pet collar for easy access.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an audio dog collar system in accordance with the disclosed architecture.

FIG. 2 illustrates a perspective view of the audio dog collar system, wherein songs and playlists are uploaded via the USB port in accordance with the disclosed architecture.

FIG. 3 illustrates a perspective view of a pet wearing the audio dog collar system in accordance with the disclosed architecture.

FIG. 4 illustrates a perspective view of multiple pets (of different sizes) wearing the audio dog collar system in accordance with the disclosed architecture.

FIG. 5 illustrates a perspective view of a user using the audio dog collar system in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Running, playing or walking with a pet while holding a music player can be inconvenient. Also, many music players require the use of headphones, which can get caught on surrounding objects while pet owners are active with their pets. It would be convenient to have a device that is able to play music aloud, is hands-free, and is convenient. The audio dog collar system allows users and their pets to listen to music while walking, running and/or playing together.

Accordingly, the disclosed audio dog collar system provides users with, among other features, a speaker system with volume control such that users may share their music with others. A pet collar secures the audio dog collar system to a pet and an audio player is secured to the pet collar for playing music. The audio player comprises a Universal Serial Bus (USB) port and/or a memory card port for uploading songs and playlists. Thus, music is played aloud while a pet walks outside, walks around inside a house, rides in a car, is held in a user's arms, etc.

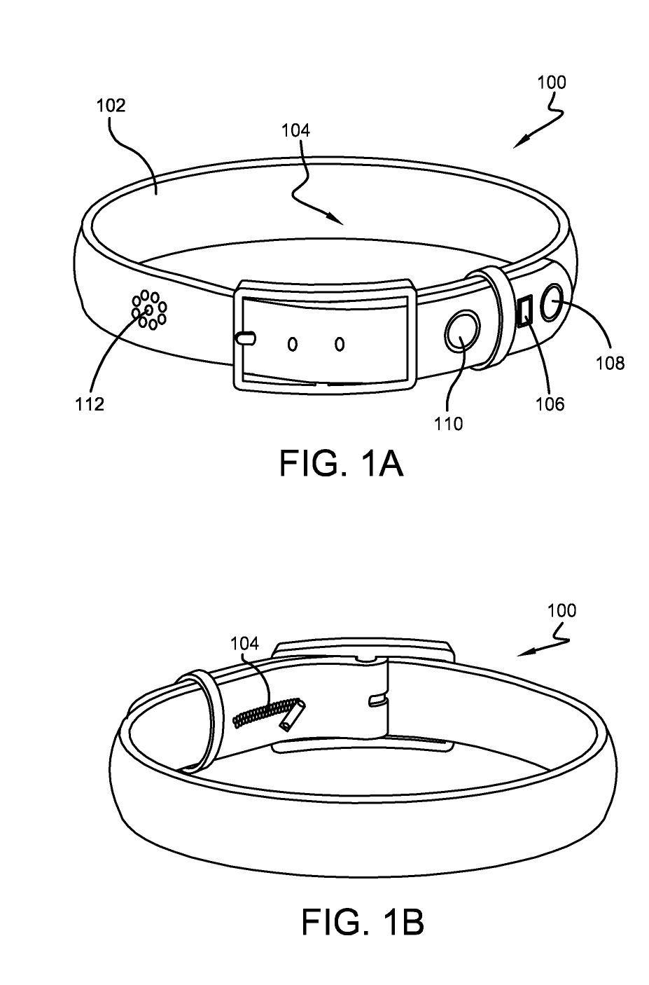

Referring initially to the drawings, FIG. 1 illustrates an audio dog collar system 100. The audio dog collar system 100 typically comprises a pet collar 102 for securing the audio dog collar system to a pet. The pet collar is typically made of synthetic material and is the standard shape and size of a typical pet collar. The pet collar 102 can be made in a variety of colors, patterns, and sizes to suit user preferences. For example, the pet collar 102 can be made to secure to small animals, such as ferrets, small dogs or cats, etc. It can also be made to secure to large animals, such as dogs, horses, etc.

Additionally, the audio dog collar system 100 comprises a programmable audio player 104 secured to the pet collar 102. The audio player 104 is typically a MP3 player, but could be any similar media player as is known in the art without affecting the overall concept of the present invention. Further, the audio player 104 is typically secured to the pet collar 102 via a zippered compartment. The zippered compartment allows for easy access in removing and charging the battery, removing and inserting the memory card and/or USB cable, volume control, playlist selection, etc. However, the audio player 104 does not have to be secured to the pet collar 102 via a zippered compartment, and can be secured to the pet collar 102 by any suitable means as is known in the art without affecting the overall concept of the present invention.

Furthermore, the audio player 104 comprises speakers 112, a rechargeable battery 108 and an on/off switch 110. The speakers 112 have volume control and music is played out through the speakers 112 which are located on the pet collar 102. The audio player 104 is powered by a built-in, rechargeable battery 108. However, any other suitable battery can be used without affecting the overall concept of the present invention. Further, an on/off switch 110 is provided for turning on and off the audio player 104.

Additionally, the audio dog collar system 100 comprises a Universal Serial Bus (USB) port 106 that allows a user to upload songs and playlists to the audio player 104. Specifically, the USB port 106 utilizes a USB cable to upload songs and playlists directly from a computer to the audio player 104. Further, the audio dog collar system 100 could also comprise a memory card port 114 that utilizes a memory card (not shown). The memory card stores songs and playlists to be uploaded to the audio player 104.

Furthermore, the audio dog collar system 100 can comprise a remote control (not shown). The remote control can be used for volume control, switching songs, and controlling other functions of the audio player 104. Use of the audio dog collar system 100 may also allow a user to easily locate their pet.

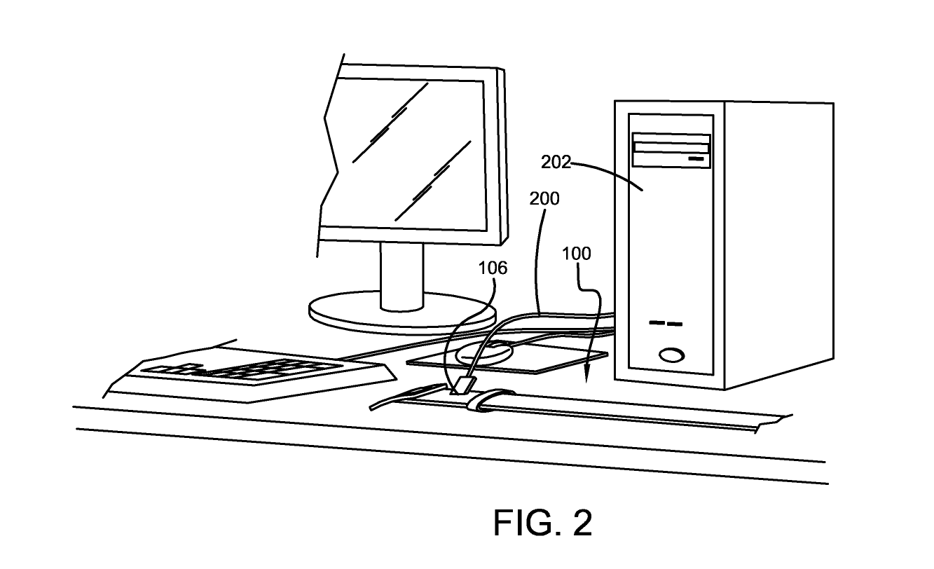

FIG. 2 illustrates the audio dog collar system 100, wherein songs and playlists are uploaded via the USB port 106. The audio dog collar system 100 comprises a USB port 106 that allows a user to upload songs and playlists to the audio dog collar system 100. Specifically, the USB port 106 utilizes a USB cable 200 to upload songs and playlists directly from a computer 202 to the audio dog collar system 100. For example, a user may download songs onto the computer 202, and then connect a USB cable 200 from the computer 202 to the USB port 106 of the audio dog collar system 100. Once the USB cable 200 is connected to the computer 202 and the USB port 106 of the audio dog collar system 100, songs and playlists are uploaded from the computer 202 directly to the audio dog collar system 100. After the uploading process is complete, a user can safely disconnect the USB cable 200 from the audio dog collar system 100 and turn on the audio dog collar system 100 via the on/off switch.

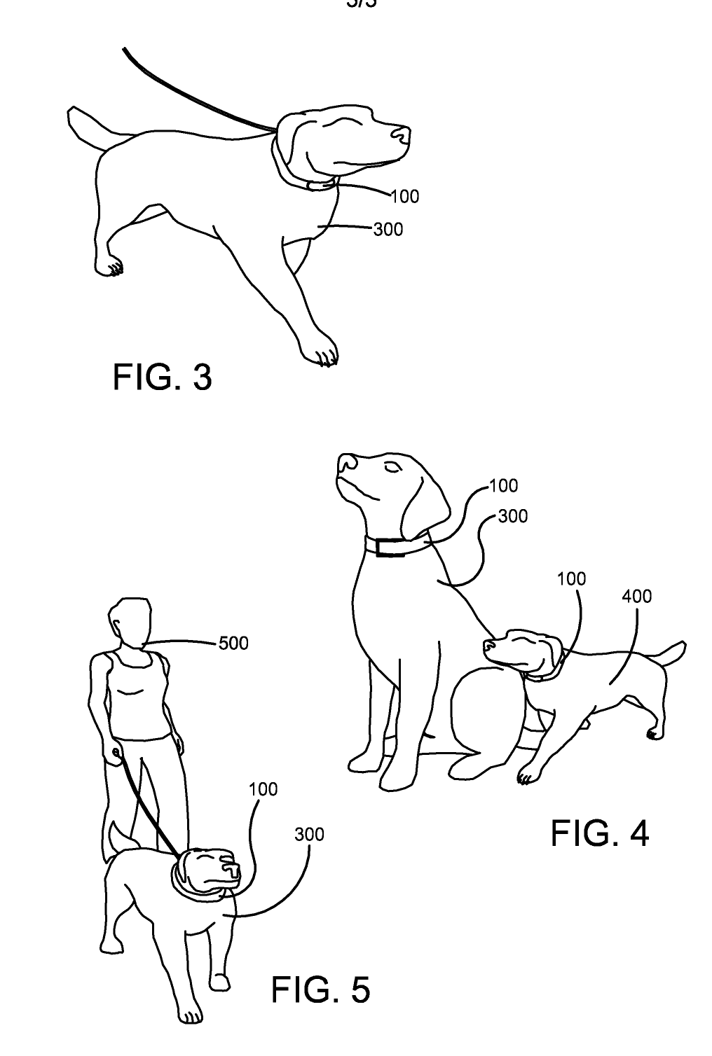

FIG. 3 illustrates a pet 300 wearing the audio dog collar system 100. In use, the audio dog collar system 100 is secured around the neck of a pet 300 via a pet collar. The audio dog collar system 100 is turned on and a user and pet 300 are able to listen to music together.

FIG. 4 illustrates multiple pets of different sizes 300 and 400 wearing the audio dog collar system 100. The audio dog collar system 100 can be made in a variety of colors, patterns, and sizes to suit user preferences. For example, the audio dog collar system 100 can be made to secure to small animals 400, such as a puppy. The audio dog collar system 100 can also be made to secure to large animals 300, such as a dog.

FIG. 5 illustrates a user 500 using the audio dog collar system 100. The audio dog collar system 100 is secured around the neck of a pet 300 via a pet collar. The audio dog collar system 100 allows a user 500 and a pet 300 to listen to music while walking, running and playing together. Furthermore, it is contemplated that the audio dog collar system 100 could be used in conjunction with an ear protection device to protect the ears of the pet wearing the device, but it is not necessary for the audio dog collar system 100 to contain an ear protection device.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An audio dog collar system comprising:
a pet collar for securing the audio dog collar to a pet; and
an audio player secured to the pet collar.

2. The audio dog collar system of claim 1, further comprising a Universal Serial Bus (USB) port for uploading songs and playlists.

3. The audio dog collar system of claim 2, wherein the USB port utilizes a USB cable to upload songs and playlists directly from a computer to the audio player.

4. The audio dog collar system of claim 1, further comprising a memory card port for uploading songs and playlists.

5. The audio dog collar system of claim 4, wherein the memory card port utilizes a memory card that stores songs and playlists to be uploaded to the audio player.

6. The audio dog collar system of claim 1, further comprising speakers.

7. The audio dog collar system of claim 6, wherein the speakers are weather-resistant and built-in to the pet collar.

8. The audio dog collar system of claim 1, further comprising a rechargeable battery.

9. The audio dog collar system of claim 1, further comprising a remote control to control operations of the audio player.

10. The audio dog collar system of claim 1, wherein the audio player is contained within a zippered compartment of the pet collar.

11. The audio dog collar system of claim 1, wherein the audio player is an MP3player.

12. The audio dog collar system of claim 1, wherein the pet comprises a dog, a cat, a horse, a ferret or other suitable pet.

13. An audio dog collar, comprising:
a pet collar; and
an audio player secured to the pet collar; and
wherein the audio player comprises a USB port for uploading songs and playlists.

14. The audio dog collar of claim 13, wherein the USB port utilizes a USB cable to upload songs and playlists directly from a computer to the audio player.

15. The audio dog collar of claim 13, further comprising a memory card port that utilizes a memory card, wherein the memory card stores songs and playlists to be uploaded to the audio player.

16. The audio dog collar of claim 13, further comprising a rechargeable battery.

17. The audio dog collar of claim 13, further comprising a remote control to control operations of the audio player.

18. An audio dog collar, comprising:
a pet collar;
an audio player secured to the pet collar;
a USB port for uploading songs and playlists; and
a remote control to control operations of the audio player.

19. The audio dog collar of claim 18, further comprising speakers that are weather-resistant and built-in to the pet collar.

20. The audio dog collar of claim 18, wherein the audio player is contained within a zippered compartment of the pet collar.
